(19) United States
(12) Patent Application Publication
(10) Pub. No.: US 2005/0217872 A1
(43) Pub. Date: Oct. 6, 2005

(54) Fire-alarm system having self-test function

(76) Inventors: Jong Hwan Oh, Gyeonggi-do (KR); Hee Yun Joung, Suwon-si (KR)

Correspondence Address: STEIN, MCEWEN & BUI, LLP, 1400 EYE STREET, NW, SUITE 300, WASHINGTON, DC, 20005, US

(21) Appl. No.: 11/092,893

(22) Filed: Mar. 30, 2005

(30) Foreign Application Priority Data
Mar. 30, 2004 (KR) 10-2004-21583
Mar. 3, 2005 (KR) 10-2005-17901

(51) Int. Cl. A62C 2/00

(52) U.S. Cl. 169/67; 169/68; 169/69; 169/70

(57) ABSTRACT

Disclosed herein is a fire alarm system having self-diagnosis functionality. The fire alarm system includes a fire detector, one or more extinguisher supports, a self-diagnosis remote controller and a controller. The fire detector detects a fire, transmits a fire signal, and exchanges radio signals. Each of the extinguisher supports internally includes an alarm sound emission device and a fog lantern device. The self-diagnosis remote controller transmits a self-diagnosis signal to check the operation of the fire detector, the extinguisher supports and the controller. The controller includes a setting means and a speaker. The controller dials the telephone numbers of designated telephones through an exchange and transmits recorded fire alarm messages to interested persons.

### BACKGROUND OF THE INVENTION

1. Field of the Invention

The present invention relates generally to a fire alarm system having self-diagnosis functionality, which notifies various places of the occurrence of a fire and allows fire extinguishers to be easily identified at the scene of the fire, thus allowing the fire to be extinguished at an early stage of the fire. In particular, the present invention relates to a fire alarm system having self-diagnosis functionality, which automatically dials the telephone numbers of designated telephones and transmits fire alarm messages at the time of a fire, and precisely notifies interested persons of the location of the fire using a human voice, so that the persons can rapidly respond to the fire and, therefore, fire damage can be minimized, which allows the locations of fire extinguishers to be rapidly and precisely identified at the scene of the fire using an alarm sound emission device and a fog lantern device mounted on each extinguisher support, so that the fire can be extinguished at an early stage of the fire, and which is provided with a self-diagnosis remote controller, so that the operation of the system may be regularly or irregularly checked and, therefore, the occurrence of a fire can be prepared for in advance.

2. Description of the Related Art

With the concentration of population in cities, the increase in the number of buildings, and the increase in the size of a building, the scale of fire damage increases, thus increasing the loss of property and lives. Accordingly, the necessity to extinguish a fire at an early stage is further increasing.

A fire alarm system is a device that detects the occurrence of a fire in a building and notifies interested persons of the occurrence of the fire using a sound emission device or the like, so that the fire can be extinguished at an early stage. A variety of fire alarm systems has been developed and used.

Prior art technologies related to fire alarm systems include Japanese Unexamined Pat. Pub. No. Hei 14-245566 (hereinafter referred to as “prior art 1”) and Korean Unexamined Pat. Appl. No. 1998-0004849 (hereinafter referred to as “prior art 2”).

The prior art 1 is constructed in such a way that a light emitting diode and an alarm device are attached to an extinguisher support, so that the location of a fire extinguisher can be easily determined at the time of a fire.

The prior art 2 relates to an unattended fire alarm system that calls a predetermined telephone number using a public telephone line at the time of a fire and transmits an appropriate previously recorded voice message.

The prior art technologies have the following problems.

First, it is very difficult to extinguish a fire using a fire extinguisher at an early stage of the fire because the time during which a person can stay at the scene of the fire is very short due to smoke and poisonous gas generated at the time of the fire. In the above-described respect, the prior art 1 allows the fire extinguisher to be easily found, but it lacks a means for allowing a user to actively utilize a fire extinguisher while protecting the user from smoke and poisonous gas.

In the prior art fire alarm system, a fire detector and peripheral devices unilaterally transmit radio signals and the transmitted signals are simply received. That is, there are no reception completion signals, so that it cannot be determined whether or not radio signals have been successfully transmitted and received. Accordingly, only transmission is performed but reception is not performed, so that there is the risk of the fire alarm system not operating.

Furthermore, there is no provision for a separate means for determining whether the fire alarm system is operative at normal times. That is, there is no method of, prior to the occurrence of a fire, checking whether the components of the fire alarm system can perform their functions.

### SUMMARY OF THE INVENTION

Accordingly, the present invention has been made keeping in mind the above problems occurring in the prior art, and an object of the present invention is to provide a fire alarm system having self-diagnosis functionality, which allows a fire detector and peripheral devices to exchange radio signals and eliminates the risk of the fire alarm system not operating or operating incorrectly.

Another object of the present invention is to provide a fire alarm system having self-diagnosis functionality, which includes a self-diagnosis remote controller, so that the operability of the fire alarm system can be checked regularly or irregularly, thus preparing for a fire in advance.

A further object of the present invention is to provide a fire alarm system having self-diagnosis functionality, in which an alarm sound emission device and a fog lantern device are mounted on an extinguisher support, so that the location of a fire extinguisher can be easily determined, and in which a gas mask storage space is formed in the extinguisher support, so that a user can use the fire extinguisher after putting on a gas mask and can be protected from smoke and poisonous gas generated at the time of a fire, thus allowing a fire to be actively extinguished at an early stage.

A still further object of the present invention is to provide a fire alarm system having self-diagnosis functionality, which automatically dials the stored telephone numbers of designated telephones and transmits previously recorded voice messages, so that interested persons can rapidly and actively respond to a fire and the fire can be extinguished at an early stage. In particular, the telephone numbers of the designated telephones and the voice messages can be input using a general home electronic telephone.

In order to accomplish the above object, the present invention provides a fire alarm system having self-diagnosis functionality, including a fire detector for detecting a fire, transmitting a fire signal, and exchanging radio signals with peripheral devices; one or more extinguisher supports for exchanging radio signals with the fire detector, each of the extinguisher supports internally comprising an alarm sound emission device and a fog lantern device to notify a user of a location of a fire extinguisher; a self-diagnosis remote controller for exchanging radio signals with the fire detector and transmitting a self-diagnosis signal to check the operation of the fire detector, the extinguisher supports and the controller; a controller comprising a setting means for inputting the telephone numbers of designated telephones using a home electronic telephone, which is connected to the system via a telephone cable, and recording fire alarm messages, a speaker for checking the fire alarm messages recorded by the setting means and a light emitting device for notifying users of the occurrence of the fire, the controller exchanging radio signals with the fire detector, dialing the telephone numbers of the designated telephones, which are input by the setting means, through an exchange, which is connected to the system via a wired telephone line, when the fire signal is received from the fire detector, and transmitting the recorded fire alarm messages to the users.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a fire alarm system having self-diagnosis functionality in accordance with an embodiment of the present invention;

FIG. 2 is a block diagram of a fire detector;

FIG. 3 is a block diagram of an extinguisher support;

FIG. 4 is a sectional view of the extinguisher support;

FIG. 5 is a block diagram of a self-diagnosis remote controller; and

FIG. 6 is a block diagram of a controller.

### DESCRIPTION OF THE PREFERRED EMBODIMENTS

The present invention is described in detail with reference to the accompanying drawings.

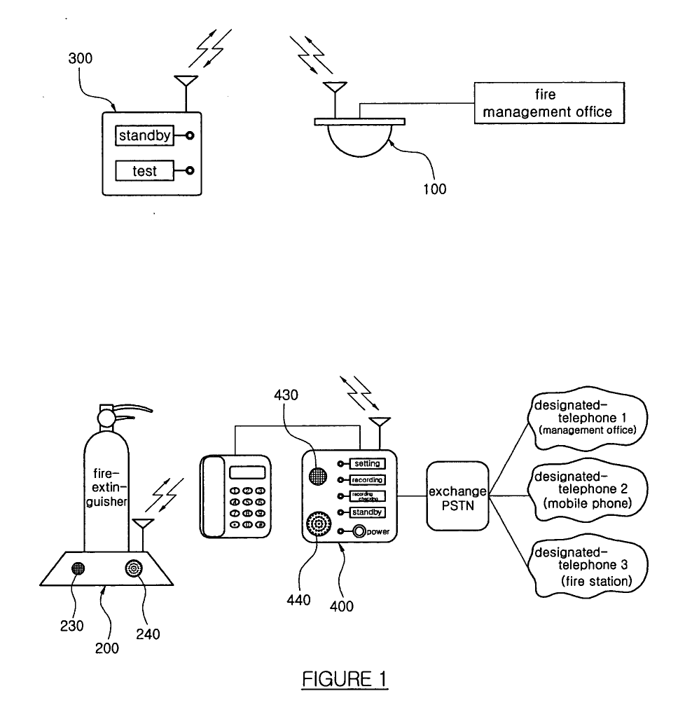

FIG. 1 is a diagram showing the construction of a fire alarm system according to an embodiment of the present invention. As shown in FIG. 1, the fire alarm system according to the present invention includes a fire detector 100 connected to a fire management office via a wired line, a plurality of extinguisher supports 200 configured to exchange radio signals with the fire detector 100 and located at various places in a building, a self-diagnosis remote controller 300 configured to check the operation of the fire alarm system, and a controller 400 connected to an exchange via a wired telephone line 451 and connected to a home electronic telephone via a telephone cable 452.

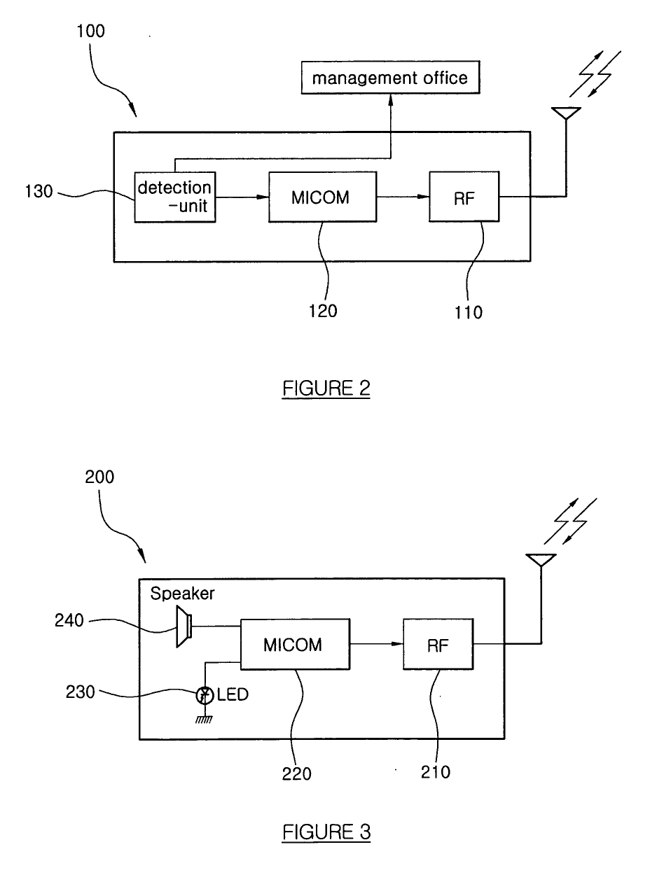

FIG. 2 is a block diagram of the fire detector 100.

As shown in FIG. 2, the fire detector 100 includes a detection unit 130 connected to the fire management office via a wired connection and configured to detect the occurrence of a fire, a Radio Frequency (RF) transceiver 110 configured to exchange radio signals with peripheral devices, and a microcomputer 120 connected to the detection unit 130 and the RF transceiver 10 and configured to perform overall functions.

FIG. 3 is a block diagram of the extinguisher support 200.

As shown in FIG. 3, the extinguisher support 200 includes an RF transceiver 210 configured to exchange radio signals with the fire detector 100, an alarm sound emission device 240 configured to inform interested persons of the location of the fire extinguisher, a fog lantern device 230 configured to radiate light, and a microcomputer 220 connected to the alarm sound emission device 240, the fog lantern device 230 and the RF transceiver 210 and configured to perform overall functions. In general, an alarm sound, such as a siren, is generally stored in the alarm sound emission device 240. However, it is possible for a user to record his voice indicating the precise location of the fire extinguisher in the alarm sound emission device 240. The fog lantern device 230 has fog penetration capability, so that it is not much influenced by smoke generated by a fire. Although not shown in the drawing, control switches for adjusting the volume of voice and the intensity of light are preferably connected to the microprocessor 220.

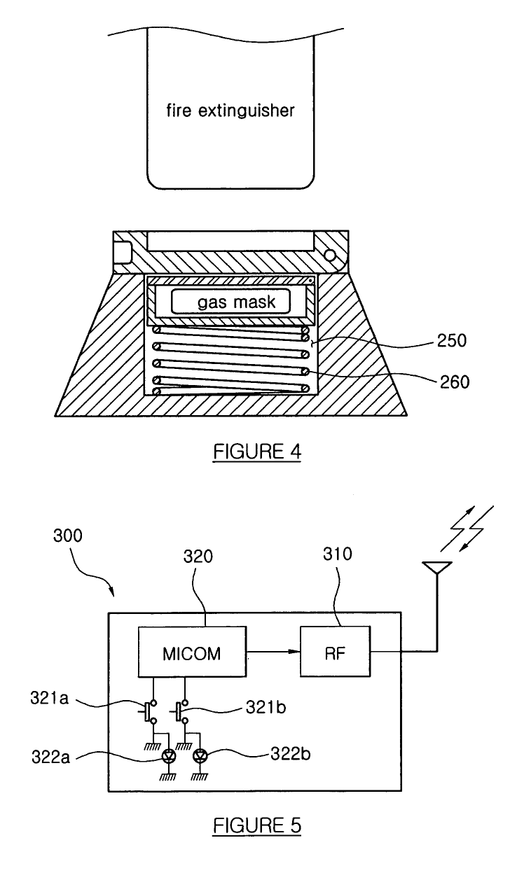

FIG. 4 is a sectional view of the extinguisher support 220.

A gas mask storage space 250 is formed inside the fire extinguisher support 200 to store a gas mask. Generally, a gas mask is stored in a building to protect a user from smoke or poisonous gas generated by the occurrence of a fire. When a fire occurs, there are cases in which the user cannot determine the location of the gas mask due to panic. Accordingly, by forming the gas mask storage space 250 in the extinguisher support 200, the gas mask can be found at the same time that the fire extinguisher is found, so that a fire can be extinguished at an early stage of a fire without the hindrance of smoke or poisonous gas. An elastic member 260, such as a spring, rubber or sponge, is preferably placed in the lower portion of the gas mask storage space 250. In this case, when the gas mask is seated in the extinguisher support 200, the gas mask is completely seated in the gas mask storage space 250 due to the weight of the gas mask, and when the gas mask is drawn from the gas mask storage space 250 for use, the user can easily and rapidly draw the gas mask from the gas mask storage space 250 due to the lifting force of the elastic member 260.

FIG. 5 is a block diagram of the self-diagnosis remote controller 300.

As shown in FIG. 5, the self-diagnosis remote controller 300 includes an RF transceiver 310 configured to exchange radio signals with the fire detector 100, a test button 321a configured to transmit a self-diagnosis signal, a standby button 321b configured to stop a self-diagnosis test, and a microcomputer 320 connected to the RF transceiver 10, the test button 321a and the standby button 321b and configured to perform overall functions.

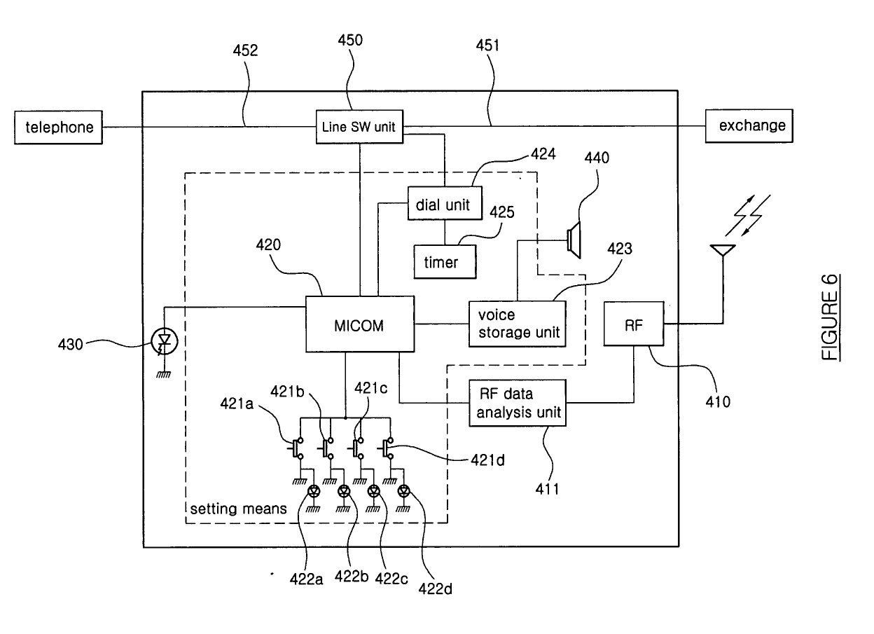

FIG. 6 is a block diagram of the controller 400.

As shown in FIG. 6, the controller 400 connected to a home electronic telephone via a telephone cable 452 and connected to an exchange via a wired telephone line 451 includes an RF transceiver 410 configured to exchange radio signals with the fire detector 100, an RF data analysis unit 411 connected to the RF transceiver 410 and configured to determine whether a received signal is a fire signal or a self-diagnosis signal, a light emitting device 430 configured to provide notification of a fire, a speaker 440, a line switch unit 450 configured to connect the telephone cable 452 with the wired telephone line 451, and a setting means configured to receive the telephone number of a designated telephone and to record voice messages. In particular, the setting means includes a setting button 421a, a recording button 421b, a recording confirmation button 421c, a standby button 421d, Light Emitting Diodes (LEDs) 422a, 422b, 422c and 422d corresponding to the buttons 421a, 422b, 422c and 422d, a voice recording unit 423, a dial unit 424 configured to store the telephone number of a designated telephone, a timer 425 connected to the dial unit 424, and a microcomputer 420 connected to the buttons 421a, 421b, 421c and 421d, the LEDs 422a, 422b, 422c and 422d, the voice recording unit 423, the dial unit 424, the light emitting device 430, the RF data analysis unit 411 and the line switch unit 450 and configured to perform overall functions.

Furthermore, although not shown in the block diagram, LEDs indicating the normal transmission and reception of radio signals are preferably included in the fire detector 100, the self-diagnosis remote controller 300, the extinguisher support 200 and the controller 400. LEDs are included in the fire detector 100, the extinguisher support 200 and the controller 400, respectively, to check the application of power, and a 12˜15 V auxiliary power source is included to provide for emergencies, such as a power failure.

Next, the operation of the self-diagnosing fire alarm system composed of the above-described elements is described below.

In the case of the occurrence of a fire:

1) When a fire occurs, the detection unit 130 of the fire detector 100 detects the occurrence of the fire, transmits a signal to the microprocessor 120, and notifies the fire management office, which is connected via the wired line, of the occurrence of the fire. The microcomputer 120, having received the signal, transmits a fire signal to the extinguisher support 200 and the controller 400 through the RF transceiver 110. If a reception completion signal indicating the reception of the fire signal is not received within a certain period (for example, 10 seconds), the fire signal is repeatedly retransmitted until the reception completion signal is received.

2) The RF transceiver 210 of the extinguisher support 200, having received the fire signal, transmits the fire signal to the microcomputer 220, and the microcomputer 220 transmits a reception completion signal to the fire detector 100 through the RF transceiver 210. The microprocessor 220, having received the fire signal, notifies persons inside and outside a building of the location of the fire extinguisher by activating the alarm sound emission device 240 and the fog lantern device 230.

3) The RF transceiver of the controller 400, having received the fire signal, transmits the fire signal to the microcomputer 420, and the microcomputer 420 immediately transmits a reception completion signal to the fire detector 100 through the RF transceiver 410. The microcomputer 420, having received the fire signal, provides notification of the occurrence of the fire through the light emitting device 430 and the speaker 440, and, at the same time, provides notification by sequentially dialing the telephone numbers of several designated telephones using the dial unit 424. If a certain telephone has not been reached within a predetermined period (for example, 30 seconds), the timer 425 interrupts an attempt at dialing, and the microcomputer 420 dials the telephone number of a next telephone using the dial unit 424. After attempts to dial the telephone numbers of all the designated telephones have been made, dialing is conducted again for only the telephones that have not been reached. When the user of a designated telephone receives a call, the microcomputer 420 transmits a voice message (for example, a correct address, and a message “fire detected now”), which was previously recorded through the voice storage unit 423. A call recipient (for example, a staff worker of a fire station, a house owner, or the staff worker of a building management office), having received the voice message, takes countermeasures appropriate to a current situation.

In the event of self diagnosis:

1) When the test button 321a positioned on the self-diagnosis remote controller 300 is pressed, the microcomputer 320 transmits a self-diagnosis signal to the fire detector 100 through the RF transceiver 310.

2) The RF transceiver 110 of the fire detector 100, having received the self-diagnosis signal, transmits the self-diagnosis signal to the microprocessor 120, and the microcomputer 120 transmits a reception completion signal to the extinguisher support 200 and the controller 400 through the RF transceiver 110. However, the self-diagnosis signal is not transmitted to the fire management office.

3) The extinguisher support 200 operates the same as in the case in which the fire signal is received.

4) The controller 400 operates the same as in the case in which the fire signal is received, but does not dial the telephone numbers of the designated telephones.

5) When the standby button 321b is pressed upon completion of the self-diagnosis test, the system returns to a standby state.

One of the characteristics of the present invention is to perform setting through a typical home electronic telephone. For this purpose, the telephone cable 452 of the home electronic telephone, the wired telephone line 451 of the exchange, and the microcomputer 420 and dial unit 424 of the controller 400 are connected to the line switch unit 450 of the controller 400. At normal times, the cable 452 and the wired telephone line 451 are connected to each other through the line switch unit 450, so that the telephone performs the normal functions of a general electronic telephone. However, when the fire signal is received, the telephone cable 452 is disconnected at the line switch unit 450, the microcomputer 420 and the dial unit 450 are connected to the wired telephone line 451, and notification of the occurrence of a fire is provided by dialing the telephone numbers of the designated telephones. When the setting button 421a is pressed to make settings, the wired telephone line 451 is disconnected and the telephone cable 452 and the microcomputer 420 are connected.

Next, a method of setting the controller 400 is described below.

1) When the setting button 421a is pressed to make settings, the wired telephone line 451 of the exchange is disconnected, and the telephone cable 452 of the home electronic telephone is connected to the microcomputer 420 of the controller 400 through the line switch unit 450. At this time, the LED 422a connected to the setting button 421a emits light, thus providing notification of the pressing of the setting button 421a. Descriptions of the emission of the LEDs 422a, 422b, 422c and 422d are omitted below.

2) After a telephone receiver is picked up, the telephone numbers of designated telephones are sequentially input by pressing the dial buttons of a telephone. The user determines the number of the designated telephones. Methods of inputting the telephone numbers of designated telephones may vary according to the program stored in the microcomputer 420. An example of the methods is described hereinafter. The sequence of inputs is as follows: the setting button 421a of the controller 400+9+1˜8+#+one beep sound+the telephone number of a designated telephone+#+one beep sound+the recording button 421b of the controller 400+message+*+two beep sounds. The setting button 421a mounted on the controller 400 is turned on, a setting button for the occurrence of a fire, that is, a dial button 9, is pressed while a telephone receiver is picked up, a sequence setting button for the telephone numbers of designated telephones is pressed, a button # indicating the start of input is pressed, the actual telephone number of a designated telephone is input when one beep sound is emitted, and the button # indicating the start of input is pressed, the recording button 421b of the controller 400 is turned on and a voice message is then recorded when one beep sound is emitted, and a button * indicting the completion of setting is pressed. At this time, two beep sounds are emitted and the setting is completed.

3) When the telephone numbers of all the designated telephones have been input through the above-described process, the standby button 421d mounted on the controller 400 is pressed. When the standby button 421d is pressed, the telephone cable 452 is connected to the wired telephone line 451 via the line switch unit 450 and the home electronic telephone performs normal telephone functions.

In the case of checking recorded voice messages:

1) The telephone cable 452 is connected to the controller 400 by pressing the recording checking button 421c mounted on the controller 400.

2) When a telephone receiver is picked up, a dial button 9 indicating the start of recorded voice checking is pressed, a dial button (for example, a button 1) indicating the sequential position of a designated number is pressed and the button * is pressed, a recorded voice message for the first designated telephone is output through the speaker 440 mounted on the controller 400.

3) After the recorded voice messages for the telephone numbers of the designated telephones have been sequentially checked through the above-described process, the telephone cable 452 is connected to the wired telephone line 451 by pressing the standby button 421d.

As described above, the present invention provides a fire alarm system having self-diagnosis functionality that allows the fire detector to exchange radio signals with the peripheral devices, that is, the extinguisher supports, the controller and the self-diagnosis remote controller, thus preventing the malfunction or erroneous function of the fire alarm system due to not receiving a fire signal or self-diagnosis signal.

Furthermore, the fire alarm system including the self-diagnosis remote controller can check the operation thereof regularly or irregularly, so that the occurrence of a fire can be prepared for in advance.

Furthermore, persons can easily determine the locations of fire extinguishers at the time of a fire because the alarm sound emission device and the fog lantern device are mounted on the extinguisher supports, and a fire extinguisher and a gas mask can be found at the same time and a user can be protected from smoke or poisonous gas caused by a fire because the gas mask storage space is formed inside the extinguisher support, thus allowing users to actively extinguish a fire at an early stage of the fire.

Meanwhile, since the telephone numbers of the designated telephones and the voice messages indicating the occurrence of a fire are stored in the controller, the telephone numbers of the designated telephones are automatically dialed and the recorded voice messages are automatically transmitted to the designated telephones, so that listeners can precisely determine the location of the fire and can respond to the fire, thus minimizing fire damage. In particular, the present invention is advantageous in that the input of the telephone numbers of the designated telephones and the recording of the voice messages are performed using a general home electronic telephone, so that separate equipment for inputting telephone numbers and recording the voice messages is not necessary and the designated telephones and the voice messages can be easily changed.

Although a preferred embodiment of the present invention has been disclosed for illustrative purposes, those skilled in the art will appreciate that various modifications, additions and substitutions are possible, without departing from the scope and spirit of the invention as disclosed in the accompanying claims.

1. A fire alarm system having self-diagnosis functionality, comprising:
a fire detector for detecting a fire, transmitting a fire signal, and exchanging radio signals with peripheral devices;
one or more extinguisher supports for exchanging radio signals with the fire detector, each of the extinguisher supports internally comprising an alarm sound emission device and a fog lantern device to notify a user of a location of a fire extinguisher;
a self-diagnosis remote controller for exchanging radio signals with the fire detector and transmitting a self-diagnosis signal to check operation of the fire detector, the extinguisher supports and the controller;
a controller comprising setting means for inputting telephone numbers of designated telephones using a home electronic telephone, which is connected to the system via a telephone cable, and recording fire alarm messages, a speaker for checking the fire alarm messages recorded by the setting means and a light emitting device for notifying users of occurrence of the fire, the controller exchanging radio signals with the fire detector, dialing telephone numbers of the designated telephones, which are input by the setting means, through an exchange, which is connected to the system via a wired telephone line, when the fire signal is received from the fire detector, and transmitting the recorded fire alarm messages to the users.

2. The system as set forth in claim 1, wherein the fire detector comprises a detection unit for detecting the occurrence of the fire, a Radio Frequency (RF) transceiver for exchanging the radio signals with the peripheral devices, a microcomputer for performing overall functions, the microcomputer being connected to the detection unit and the RF transceiver, and a wired line for notifying a fire management office of the occurrence of the fire, the wired line being connected to the detection unit.

3. The system as set forth in claim 1, wherein the extinguisher support internally comprises an RF transceiver for exchanging radio signals with the fire detector, and a microcomputer for performing overall functions, the microcomputer being connected to the alarm sound emission device and the fog lantern device.

4. The system as set forth in claim 1, wherein the self-diagnosis remote controller internally comprises an RF transceiver for exchanging radio signals with the fire detector and a microcomputer for performing overall functions, the microcomputer being connected to the RF transceiver, and externally comprises a test button for transmitting the self-diagnosis signal and a standby button for returning the system to a standby state, the test and self-diagnosis buttons being connected to the microcomputer.

5. The system as set forth in claim 1, wherein the setting means of the controller comprises a microcomputer for controlling overall functions of the controller, a dial unit for storing the telephone numbers of the designated telephones, setting, recording, recording checking and standby buttons, the buttons being connected to the microcomputer, and Light Emitting Diodes (LEDs) for checking operation of the buttons.

6. The system as set forth in claim 1, wherein the controller comprises an RF transceiver for exchanging radio signals with the fire detector and an RF data analysis unit for determining whether a received signal is the fire signal or self-diagnosis signal, the RF data analysis unit being connected to the RF transmitter and the microcomputer of the setting means.

7. The system as set forth in claim 1, wherein the controller internally comprises a line switch unit that is connected to the telephone cable, the wired telephone line, the microcomputer of the setting means and the dial unit and operates in such a way as to connect the telephone cable and the wired telephone line to each other in a normal standby state so that the home electronic telephone can perform a normal telephone function, to disconnect the telephone cable and automatically connect the microcomputer of the setting means and the dial unit to the wired telephone line when the fire signal is received, and to disconnect the wired telephone line and automatically connect the telephone cable to the microcomputer of the setting means and the dial unit when the setting button is turned on to make settings.

8. The system as set forth in claim 1, wherein each of the extinguisher supports further comprises a gas mask storage space formed therein.

9. The system as set forth in claim 2, wherein the controller comprises an RF transceiver for exchanging radio signals with the fire detector and an RF data analysis unit for determining whether a received signal is the fire signal or self-diagnosis signal, the RF data analysis unit being connected to the RF transmitter and the microcomputer of the setting means.

10. The system as set forth in claim 3, wherein the controller comprises an RF transceiver for exchanging radio signals with the fire detector and an RF data analysis unit for determining whether a received signal is the fire signal or self-diagnosis signal, the RF data analysis unit being connected to the RF transmitter and the microcomputer of the setting means.

11. The system as set forth in claim 4, wherein the controller comprises an RF transceiver for exchanging radio signals with the fire detector and an RF data analysis unit for determining whether a received signal is the fire signal or self-diagnosis signal, the RF data analysis unit being connected to the RF transmitter and the microcomputer of the setting means.

12. The system as set forth in claim 5, wherein the controller comprises an RF transceiver for exchanging radio signals with the fire detector and an RF data analysis unit for determining whether a received signal is the fire signal or self-diagnosis signal, the RF data analysis unit being connected to the RF transmitter and the microcomputer of the setting means.

13. The system as set forth in claim 2, wherein the controller internally comprises a line switch unit that is connected to the telephone cable, the wired telephone line, the microcomputer of the setting means and the dial unit and operates in such a way as to connect the telephone cable and the wired telephone line to each other in a normal standby state so that the home electronic telephone can perform a normal telephone function, to disconnect the telephone cable and automatically connect the microcomputer of the setting means and the dial unit to the wired telephone line when the fire signal is received, and to disconnect the wired telephone line and automatically connect the telephone cable to the microcomputer of the setting means and the dial unit when the setting button is turned on to make settings.

14. The system as set forth in claim 3, wherein the controller internally comprises a line switch unit that is connected to the telephone cable, the wired telephone line, the microcomputer of the setting means and the dial unit and operates in such a way as to connect the telephone cable and the wired telephone line to each other in a normal standby state so that the home electronic telephone can perform a normal telephone function, to disconnect the telephone cable and automatically connect the microcomputer of the setting means and the dial unit to the wired telephone line when the fire signal is received, and to disconnect the wired telephone line and automatically connect the telephone cable to the microcomputer of the setting means and the dial unit when the setting button is turned on to make settings.

15. The system as set forth in claim 4, wherein the controller internally comprises a line switch unit that is connected to the telephone cable, the wired telephone line, the microcomputer of the setting means and the dial unit and operates in such a way as to connect the telephone cable and the wired telephone line to each other in a normal standby state so that the home electronic telephone can perform a normal telephone function, to disconnect the telephone cable and automatically connect the microcomputer of the setting means and the dial unit to the wired telephone line when the fire signal is received, and to disconnect the wired telephone line and automatically connect the telephone cable to the microcomputer of the setting means and the dial unit when the setting button is turned on to make settings.

16. The system as set forth in claim 5, wherein the controller internally comprises a line switch unit that is connected to the telephone cable, the wired telephone line, the microcomputer of the setting means and the dial unit and operates in such a way as to connect the telephone cable and the wired telephone line to each other in a normal standby state so that the home electronic telephone can perform a normal telephone function, to disconnect the telephone cable and automatically connect the microcomputer of the setting means and the dial unit to the wired telephone line when the fire signal is received, and to disconnect the wired telephone line and automatically connect the telephone cable to the microcomputer of the setting means and the dial unit when the setting button is turned on to make settings.

17. The system as set forth in claim 2, wherein each of the extinguisher supports further comprises a gas mask storage space formed therein.

18. The system as set forth in claim 3, wherein each of the extinguisher supports further comprises a gas mask storage space formed therein.

19. The system as set forth in claim 4, wherein each of the extinguisher supports further comprises a gas mask storage space formed therein.

20. The system as set forth in claim 5, wherein each of the extinguisher supports further comprises a gas mask storage space formed therein.
